(19) United States
(12) Patent Application Publication
(10) Pub. No.: US 2007/0294836 A1
(43) Pub. Date: Dec. 27, 2007

(54) Dialdehyde condensates containing acid groups

(75) Inventors: Nils Brinkmann, Valbrembo (IT); Martin Kleban, Leverkusen (DE); Karl-Heinz Lammich, Koln (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/820,405

(22) Filed: Jun. 19, 2007

(30) Foreign Application Priority Data
Jun. 26, 2006 (DE) 10 2006 029 408.4

(51) Int. Cl. C14C 3/08

(52) U.S. Cl. 8/94.33

(57) ABSTRACT

Condensates containing acid groups and based on
a) aldehydes, the aldehyde being selected from the group consisting of the dialdehydes of groups C₂ to C₁₂, and
b) at least one compound carrying NH₂ groups, acid group being understood as meaning sulpho and/or carboxyl groups and salts thereof.

The invention relates to dialdehyde condensates containing acid groups and salts thereof processes for the preparation thereof their use as leather auxiliaries, in particular as tanning and retanning agents, and the leathers and furs tanned and retanned therewith.

The production of leathers and furs from hides and skins takes place as a rule in a plurality of steps. After the preparatory steps of the beamhouse, such as unhairing, fleshing, delining and bating, a typical sequence consists of tanning, retanning, dyeing, fatliquoring and finishing. The individual operations may also be divided into further subunits.

While the tanning leads to an increase in the shrinkage temperature of the leather, the retanning has scarcely any influence thereon. Retanning is understood as meaning the aftertreatment of pretanned, often chrome tanned leather, in order to optimize colour, levelness, softness, fullness and the behaviour towards water (water repellency) and to fixed tanning agents. In particular, the tanning, retanning and dyeing are usually carried out in different so-called tanning drums with the use of aqueous tanning agent/retanning agent solutions or dispersions or dye solutions.

Condensates as retanning agents for leather have already been described, for example, in U.S. Pat. No. 3,063,781, EP-A-63 319, DE-A-19 823 155, U.S. Pat. No. 4,656,059, WO 94/10231, GB-A-2 371 559 and DE-A-4 436 182.

EP-A 063 319 describes a process for the preparation of water-soluble resin tanning agents from melamine, urea, formaldehyde and sodium hydrogen sulphite as a retanning agent for leather.

However, these condensates still have disadvantages in the case of the leathers retanned therewith, in particular in the fullness, softness, damp, hand, grain tightness and dyeability.

Surprisingly, the condensates according to the invention have a substantially improved property spectrum; in particular, improved grain tightness, fullness, dyeability and hand are to be found.

At the same time, the leathers treated with the condensate according to the invention are distinguished by freedom from formaldehyde according to DIN 53 315, an advantage which is also to be regarded as being very positive.

Surprisingly, condensates containing acid groups and based on
a) aldehydes, the aldehyde being selected from the group consisting of the dialdehydes of groups C₂ to C₁₂, and
b) at least one compound carrying NH₂ groups,
   acid group being understood as meaning sulpho and/or carboxyl groups and salts thereof, have now been found.

“Based on” means that the condensate is optionally prepared from further reactants in addition to a), b) and optionally c) and reactants introducing acid groups.

The respective groups a) and b) are, however, definitive with regard to the aldehydes or compounds carrying NH₂ groups which are used. This means that no other aldehyde, in particular no monoaldehyde, is used as a component if it does not satisfy the definition of a). For clarification, it should be mentioned that, for example formaldehyde, since it is a C₁-monoaldehyde—is not suitable as a reactant for the condensates according to the invention. Preferred condensates according to the invention are composed of more than 95% by weight, in particular more than 99% by weight, of the components a), b), c) and reactants were introduced into the acid groups.

Suitable dialdehydes of component a) are aliphatic as well as aromatic C₂-C₁₂-dialdehydes. Aliphatic, in particular C₂-C₈-dialdehydes are preferred. One or more compounds from the group consisting of glyoxal, butanedialdehyde, butenedialdehyde, glutardialdehyde, adipaldehyde and octanedialdehyde are particularly preferred as the dialdehyde of component a).

Glutardialdehyde is particularly preferred.

In particular, primary amines and amides are suitable as compounds of component b) which contain NH₂ groups. These are preferably aliphatic or aromatic C₁-C₁₀-amines and/or C₁-C₁₀-amides. Cyanamide, urea, melamine, urotropin, guanidine, formoguanamine, benzoguanamine, acetoguanamine, caprinoguanamine, isobutyroguanamine, acrylamide, benzamide, dicyandiamide (cyanoguanidine) or mixtures thereof are particularly preferably used.

Melamine or melamine in combination with urea is preferably used.

The condensates according to the invention carry sulpho and/or carboxyl groups or salts thereof.

Preferred salts are alkali metal, alkaline earth metal or ammonium salts, particularly preferably in the form of their sodium or potassium salts.

Preferred acid groups are sulpho groups or their salts.

Suitable reactants for introducing the acid groups, in particular the sulpho groups, are, for example, concentrated sulphuric acid, oleum, chlorosulphonic acid, alkali metal, alkaline earth metal or ammonium disulphite, alkali metal, alkaline earth metal or ammonium hydrogen sulphite, alkali metal, alkaline earth metal or ammonium sulphamate or mixtures of these reactants.

For introducing the carboxyl groups, for example, oxidations of alkyl groups, alkene groups, aldehyde groups or alcohol groups, the hydrolysis of amides, esters or acyl chlorides, the incorporation of carboxylic acid-carrying compounds or the incorporation of acyl chloride-carrying, ester-carrying or amide-carrying compounds and subsequent hydrolysis thereof are suitable.

In the introduction of the acid groups, in particular the OH groups generated from the reaction of the amines with the aldehydes are converted into acid groups, in particular into sulpho groups.

As preferred component c) optionally to be concomitantly used, one or more aliphatic or aromatic alcohols are concomitantly used as further components. For example methanol, ethanol, propanol, ethanediol, diethanolamine, glycerol, triethanolamine and phenol are preferred.

Ethanol, ethanediol, diethanolamine, glycerol, triethanolamine and phenol are particularly preferred.

The amount of acid groups is preferably 40 to 180 mol %, based on the sum of the amount of dialdehyde a) used.

It is preferable to use the components a) and b) in the following ratio:

a) 10 to 90% by weight,

b) 10 to 90% by weight, and

the percentages of a) and b) summing to 100%.

The compounds according to the invention preferably have an average molecular weight of 500 to 50 000 g/mol, in particular of 2000 to 15 000 g/mol, and preferably have a residue-free water solubility or water emulsifiability at 20° C. of more than 50 g/l.

The condensates can be used as solids, for example as powder or granules, or as aqueous solutions or dispersions.

The invention furthermore relates to a process for the preparation of the compounds according to the invention, characterized in that the components a) and b) and optionally further components are condensed, and the reaction with reactants introducing acid groups is effected before, during or after the condensation.

The condensation can be effected, for example, with the use of basic or acidic catalysts or completely without catalysts.

The condensation reaction can be effected in aqueous solution at temperatures of 20° C. to 200° C. in a basic or acidic medium. The sequence of addition of the reactants and the manner in which the reaction is carried out do of course influence the properties of the resulting product, such as, for example, the molecular weight.

The introduction of sulpho groups can be effected before, during or after the condensation, for example by

1) reaction with concentrated sulphuric acid or

2) reaction with oleum or

3) reaction with chlorosulphonic acid or

4) reaction with alkali metal, alkaline earth metal or ammonium disulphites or

5) reaction with alkali metal, alkaline earth metal or ammonium hydrogen sulphites or

6) reaction with alkali metal, alkaline earth metal or ammonium sulphamates or

a mixture of the above sulphonation possibilities 1) to 6).

In a preferred embodiment, the introduction of sulpho groups is effected by reaction with sodium disulphite in such a way that sodium disulphite is reacted with a part of the dialdehyde component a) and the amine or amide component b) in an aqueous medium at temperatures of 20 to 200° C., preferably at 20 to 150° C., particularly preferably beginning at 20-50° C. and ending at 70 to 140° C. After the reaction, reaction is optionally effected with further dialdehyde component (a) at temperatures of 20 to 200° C., preferably 60 to 200° C., particularly preferably 70 to 140° C.

The invention furthermore relates to the use of the compounds according to the invention and mixtures containing the compounds according to the invention for tanning hides or skins or for retanning mineral tanned leathers, in particular chrome tanned leathers, characterized in that the hides or skins or the tanned leather are or is treated with the condensate according to the invention in aqueous liquor.

The invention also relates to leathers or furs which are tanned or retanned using the compounds according to the invention.

The use of tanning/retanning agents is known per se to the person skilled in the art.

The invention also relates to a process for tanning hides or skins or for retanning mineral tanned leather wherein hides or skins or mineral tanned leather are treated with condensates or mixtures of the present invention in aqueous liquor.

In a preferred use, the leathers or furs according to the invention are produced by adjusting commercially available Wet Blue to a pH of 3.8 to 7.0, preferably 4.5 to 6.0 in a commercially available tanning apparatus, such as a tanning drum, mixer or dosamat, and then retanning it in aqueous liquor with 2-20% of the retanning agent according to the invention alone or in combination with further retanning agents/dyes/fatliquoring agents. The leather thus treated can be further processed in the customary manner.

Leathers which are tanned or retanned with the substance according to the invention have particular fullness and grain tightness, in particular in the flank regions, in addition to softness.

The substance according to the invention can of course also be used in combination with further additives. For example, neutralizing agents, fillers, buffers, dispersants, antifoams, fats, water repellents, dyeing auxiliaries and other tanning/retanning agents are suitable as such.

The additives can be used, for example, by simultaneous addition to the tanning drum or stepwise addition to the same liquor. A mixture with the additives to give a storage-stable product in liquid or solid form is preferred.

Additives having a good dispersing effect, for example based on formaldehyde condensates obtained from formaldehyde and at least one aromatic compound from the group consisting of naphthalenesulphonic acids, cresolsulphonic acids, phenolsulphonic acids, ditolyl ether sulphonic acids, bishydroxyphenyl sulphone and phenols, are particularly preferred here.

Fillers used may be inorganic fillers, such as silicates, zeolites or talc; from the group consisting of the organic fillers, for example, starches, modified starches or ligninsulphonates are used.

The invention furthermore relates to mixtures containing
(i) at least one condensate according to the invention,
(ii) at least one dispersant, in particular one based on formaldehyde condensates obtained from formaldehyde and at least one aromatic compound from the group consisting of napthalenesulphonic acids, cresolsulphonic acids, phenolsulphonic acids, ditolyl ether sulphonic acids, bishydroxyphenyl sulphone and phenols, and
(iii) at least one filler, in particular ligninsulphonates.

The proportion of the component is preferably

(i) 30-80% by weight, in particular 50-75% by weight,

(ii) 10-60% by weight, in particular 15-40% by weight,

(iii) 10-60% by weight, in particular 15-40% by weight,

based in each case on the sum of the components (i) to (iii) of the mixture.

The mixture according to the invention nay be present as a solid or as a liquid preparation, preferably as an aqueous solution. As a solid, the mixture is preferably present as powder or granules, the sum of (i)-(iii), based on the mixture, preferably accounting for more than 90% by weight, in particular more than 95% by weight.

The solids content of the liquid preparation is preferably 30-70% by weight, this in particular being accounted for by more than 90% by weight, preferably more than 95% by weight, of components (i)-(iii).

The invention furthermore relates to the use of the substance according to the invention or of the mixture according to the invention as an auxiliary for paper or textile applications.

In the context of this invention, all combinations of the general ranges disclosed above and of the preferred ranges and of the preferred ranges relative to one another are also considered to be disclosed preferred ranges.

### EXAMPLES

### Example 1

1400 g of water are initially introduced at 30° C. and 798 g of sodium disulphite are added with stirring. 252 g of melamine and 10 g of borax are added to the solution and the batch is heated to 100° C. In the course of 2 hours, 1088 g of 50% glutardialdehyde solution are metered in at 98-102° C. and the reaction mixture is stirred for 3 h until a clear solution has formed. This is evaporated to dryness on a rotary evaporator and milled.

### Example 2

410 g of aqueous 50% glutardialdehyde solution are metered into 1100 g of 38% sodium bisulphite solution beginning at 30° C. The temperature increases to 55° C. After addition of 94.6 g of melamine and 22.5 g of urea, the mixture is heated to 95° C. for 2 h, after which 205 g of aqueous, 50% strength by weight glutardialdehyde solution are metered in in the course of 30 minutes and stirring is effected at 94-98° C. for 10 h. Evaporation to dryness is effected and spray drying is carried out at 180° C.

### Example 3

400 g of sodium disulphite are dissolved in 700 g of water and then 63 g of melamine, 5 g of borax and 45 g of urea are added. Heating is effected, and 544 g of 50% glutardialdehyde solution are metered in from 70° C. so that 95° C. are not exceeded. At 103-108° C., stirring is effected for 2 h. Evaporation to dryness and milling are effected.

### Example 4

1000 g of water are initially introduced at room temperature and 475 g of sodium disulphite are added. Addition of 540 g of 25% glutardialdehyde solution is effected beginning at 30° C. After addition of 150 g of melamine and 75 g of ethanediol, stirring is effected for 15 minutes at 55° C. Heating to 95° C. is effected and 80 g of glyoxal and 10 g of methanesulphonic acid are added in the course of 30 minutes. At 95-98° C., stirring is effected for 6 h. Evaporation to dryness is effected on a rotary evaporator and drying is carried out at 100° C.

### Example 5

180 g of phenolsulphonic acid are initially introduced into 1270 g of 36.5% sodium bisulphite solution at room temperature. 490 g of 50% glutardialdehyde solution are added beginning at 30° C. The temperature increases to 70° C. After addition of 140 g of melamine and 60 g of phenol, heating to 95° C. is effected and stirring is carried out for 6 h. Evaporation to dryness is effected on a rotary evaporator and drying is carried out at 100° C.

### Example 6

110 g of a solution of a synthetic tanning auxiliary based on a condensate of formaldehyde and ditolyl ether sulphonic acids (“auxiliary 1”) are added to 180 g of a product solution obtained according to Example 2. The mixture is converted into powder in a spray dryer at 160° C. and 70 g of the product thus obtained are dry-blended with 30 g of talc.

Further products are prepared in an analogous manner (amounts used based on solids content of the finished product)

| | No. | | | | | | |
|---|---|---|---|---|---|---|---|
| | 6a | 6b | 6c | 6d | 6e | 6f | 6g |
| Product from example | 2 | 1 | 2 | 2 | 4 | 3 | 1 |
| Amount [%] | 40 | 50 | 50 | 30 | 60 | 70 | 65 |
| Mixed product before drying | | | | | | | |
| Auxiliary 1 | | 20 | | | | | 15 |
| Auxiliary 2 | 30 | | | 20 | | | |
| Retanning agent 1 | | | 25 | | | | |
| Ligninsulphonate, Na salt | | 30 | | | | 30 | |
| Mixed product after drying | | | | | | | |
| Ligninsulphonate, Ca salt | 30 | | | 20 | | | |
| Talc | | | | 20 | 20 | | 20 |
| Zeolite | | | | | 20 | | |
| Sodium sulphate | | | 25 | 10 | | | |

Auxiliary 1: condensate based on ditolyl ether sulphonic acids and formaldehyde, sodium salt (corresponds to the condensate from comparative example 2 of EP-A-1568788)

Auxiliary 2: condensate based on naphthalenesulphonic acids and formaldehyde, sodium salt (corresponds to condensate D from EP-A-1416058)

Retanning agent 1: condensate based on phenol, phenolsulphonic acid, urea and formaldehyde, sodium salt (corresponds to condensate E from EP-A-1416058)

### Comparative Example 1

### Comparative Product from EP-A-063319

### Example 1

92 parts of a 65% strength aqueous solution of a condensate of 34 parts of urea, 30 parts of formaldehyde and 15 parts of melamine (viscosity: 85 sec., 4 mm Ford cup at 20° C.) are stirred in 50 parts of water with 52 parts of sodium hydrogen sulphite and 30 parts of urea for 2 h at 90° C. Thereafter, 50 parts of 30% strength formaldehyde solution are added dropwise, dilution is effected with 40 parts of water and stirring is effected for 5 h at 90° C.

### Comparative Example 2

### Commercially Available Resin Tanning Agent

680 parts of formalin (30% strength) are diluted with 96 parts of water, and 100 parts of sodium disulphite are added at 50° C. 32 parts of melamine are added, stirring is effected for 15 min and heating with 69 parts of formalin to 95° C. is carried out. After stirring for 2 h at 95° C., dilution is effected with 400 parts of water, 120 parts of sodium sulphate are added and the mixture is converted into a solid by spray drying.

### Use Example 1

### Model Retanning Formulation

Wet Blue (cattle, 100 g) is agitated in a drum with 100% water (stated percentages always based on the Wet Blue weight), 1% of sodium formate and 0.8% of sodium bicarbonate overnight at 40° C. After discharge of the liquor and washing, agitation is effected in the drum with 100% of water and 5% of the test product (the stated percentage is based on the solids content) at 40° C. for 2 hours. Finally, the leathers are agitated with 300% of water and 10% of a commercially available fat liquid mixture for 90 minutes at 50° C. in the drum. After addition of 2.5% of formic acid (85% strength) and further treatment in the drum for 15 minutes, washing, setting out and hanging to dry are effected.

Rating of the leathers:

| | Example | | | | |
|---|---|---|---|---|---|
| Product | 2 | 6a | 6g | Comp. 1 | Comp. 2 |
| Fullness | ++ | ++ | +++ | ++ | ++ |
| Colour | +++ | ++ | +++ | + | ++ |
| Grain tightness | +++ | +++ | ++ | + | + |
| Free formaldehyde | n.d. | n.d. | n.d | 146 ppm | 115 ppm |

n.d. = non detectable

The leathers obtained were investigated according to the test method DIN 53315 “Detection of free formaldehyde in leather”.

### Use Example 2

### Retanning for Automotive Leather

Raw material: Wet Blue, cattle, shaved thickness 1.2 mm, weight about 2 kg. Stated amounts are based on shaved weight.

| | | | | | Time | |
|---|---|---|---|---|---|---|
| | | % | Product | | min | Remark |
| Washing | | 300 | Water 40° C. | | | |
| | | | | | 15 | pH 3.6 |
| | | | | | | Liquor discharged |
| Neutralization | | 100 | Water 30° C. | | | |
| | | 1.0 | Sodium formate | | | |
| | | 2.0 | Neutralization tanning agent | | 15 | |
| | | 1.0 | Sodium bicarbonate | | 10 | |
| | + | 3.0 | Synthetic fatliquoring agent | 1:3 | 60 | pH 5.8 |
| | | | | | | Liquor discharged |
| Washing | | 200 | Water 30° C. | | 10 | |
| | | | | | | Liquor discharged |
| Retanning | | 50 | Water 30° C. | | | |
| | | 4.0 | Synthetic fatliquoring agent | 1:3 | 20 | |
| | | 4.0 | Synthetic retanning agent | | | |
| | | 4.0 | Test product | | | |
| | | 4.0 | Vegetable tanning agent Tara | | 20 | |
| | | 3.0 | Grey dye | | 60 | Penetration test |
| | + | 50 | Water 60° C. | | | Heating 50° C. |
| | | 1.0 | 85% formic acid | 1:10 | 15 | |
| | | 1.0 | 85% formic acid | 1:10 | 20 | pH 3.9 |
| | | | | | | Liquor discharged |
| Fatliquoring | + | 150 | Water 60° C. | 1:3 | 60 | |
| | + | 10 | Synthetic fatliquoring agent | | 5 | |
| | + | 1.0 | 85% formic acid | 1:10 | 30 | pH 3.8 |
| | | | | | | Liquor discharged |
| Washing | | 200 | Water 20° C. | | 10 | |
| | | | | | | Liquor discharged |

Leather on horse, set out, clamp oil wet, condition, stake, mill overnight.

The grey leather obtained using the product according to the invention from Example 6b is distinguished by particular, uniform grain tightness and fine milled pattern. The loose-grained, empty regions at neck and flanks are substantially smaller than in the case of a leather produced analogously using the product according to Comparative Example 2. In a control measurement according to DIN 53315, no formaldehyde was detectable for the leather according to the invention, while the leather of Comparative Example 2 has 58 ppm.

### Use Example 3

### Retanning for Shoe Upper Leather

Raw material: Wet Blue, cattle, shaved thickness 1.4 mm; stated amounts are based on shaved weight.

| | | | Time | |
|---|---|---|---|---|
| % | Product | | min | Remark |
| 200 | Water 40° C. | | | |
| 0.1 | Nonionic wetting agent | | | |
| 0.2 | Formic acid | 1:10 | 20 | pH: 3.4 |
| | | | | Discharge |
| 100 | Water 35° C. | | 10 | |
| | | | | Discharge |
| 100 | Water 35° C. | | | |
| 3.0 | Chrome tanning agent | | | |
| 2.0 | Complexing basifying agent | | 90 | pH 3.6 |
| 1.0 | Sodium formate | | | |
| 0.4 | Sodium bicarbonate | | 40 | |
| 100 | Water 50° C. | | | |
| | | | Over- | pH 4.0 |
| | | | night | |
| | | | | Discharge |
| 150 | Water 35° C. | | 10 | |
| | | | | Discharge |
| 150 | Water 35° C. | | | |
| 1.5 | Neutralization tanning agent | | | |
| 0.2 | Sodium bicarbonate | | 60 | pH 4.9 |
| | | | | Discharge |
| 100 | Water 25° C. | | | |
| 2.0 | Dispersing polymer tanning agent | 1:4 | 5 | |
| 4.0 | Polyacrylate | 1:4 | 15 | |
| 5.0 | Synthetic tanning agent | | | |
| 4.0 | Test product | | | |
| 4.0 | Chestnut vegetable tanning agent | | 10 | |
| 2.5 | Brown dye mixture | | 60 | |
| 100 | Water 50° C. | | | Heating 50° C. |
| 1.3 | 85% formic acid | 1:10 | 30 | pH 3.5 |
| | | | | Discharge |
| 150 | Water 50° C. | | | |
| 6.0 | Softening polymer tanning agent | | | |
| 3.0 | Fish oil-based fatliquoring agent | | | |
| 0.5 | Lecithin-based fatliquoring agent | | 60 | |
| 1.3 | Formic acid | | 30 | pH 3.4 |
| | | | | Discharge |
| 150 | Water 60° C. | | | |
| 0.3 | Brown dye mixture | | 20 | |
| 0.5 | Formic acid | 1:10 | 20 | |
| | | | | Discharge |
| 200 | Water 50° C. | | | |

Leather on horse, setting out, vacuum drying 2 min at 60° C., hanging to dry, stacking, vacuum drying for 30 sec at 60° C.

The leather obtained using the product from Example 2 is distinguished by particular fullness and a dry hand. It is substantially more tight-grained than a leather produced analogously without the product according to the invention or with the product from Comparative Example 2. In a control measurement according to DIN 53315 without test product and with the product according to the invention, no formaldehyde was detectable, while 44 ppm were found with the product from Comparative Example 2.

1. Condensates containing acid groups and based on
a) aldehydes, the aldehyde being selected from the group consisting of the dialdehydes of groups C₂ to C₁₂, and
b) at least one compound carrying NH₂ groups,
acid group being understood as meaning sulpho and/or carboxyl groups and salts thereof.

2. The Condensates according to claim 1, wherein the aldehydes of component a) are aliphatic dialdehydes.

3. The Condensates according to claim 1, wherein the aldehydes of component a) are aliphatic C₂-C₈-dialdehydes.

4. Condensates according to claim 1, wherein the aldehydes of component a) are selected from the group consisting of glyoxal, butanedialdehyde, butenedialdehyde, glutardialdehyde, adipaldehyde and octanedialdehyde, in particular glutardialdehyde.

5. Condensates according to claim 1, wherein the aldehyde of component a) is glutardialdehyde.

6. Condensates according to claim 1, wherein the compounds of component b) are primary amides and/or amides.

7. Condensates according to claim 1, wherein the compounds of component b) are primary aliphatic or aromatic C₁-C₁₀-amines and/or C₁-C₁₀-amides.

8. Condensates according to claim 1, wherein the compounds of component b) are urea, melamine, urotropin, guanidine, formoguanamine, benzoguanamine, acetoguanamine, caprinoguanamine, isobutyroguanamine, acrylamide, benzamide, dicyandiamide (cyanoguanidine) or mixtures thereof.

9. Condensates according to claim 1, wherein the compounds of component b) are melamine and/or urea.

10. Condensates according to claim 1, wherein alkali metal, alkaline earth metal or ammonium salts are suitable as salts of the acid groups.

11. Condensates according to claim 1, wherein as a further component, one or more aromatic or aliphatic alcohols are used as component c).

12. Condensates according to claim 1, wherein as a further component, one or more compounds selected from the group consisting of methanol, ethanol, propanol, ethanediol, diethanolamine, glycerol, triethanolamine and phenol are used as component c).

13. A Process for the preparation of condensates according to claim 1, wherein the components a) and b) and optionally further components are condensed, and the reaction with reactants introducing acid groups is effected before, during or after the condensation.

14. Mixtures containing
(i) at least one condensate according to claim 1,
(ii) at least one dispersant and
(ii) at least one filler.

15. Mixtures according to claim 14 containing
(i) at least one condensate according to claim 1,
(ii) at least one dispersant based on condensates of formaldehyde and at least one aromatic compound selected from the group consisting of napthalenesulphonic acids, cresolsulphonic acids, phenolsulphonic acids, ditolyl ether sulphonic acids, bishydroxyphenyl sulphone and phenols, and
(iii) at least one filler.

16. A process for tanning hides or skins or for retanning mineral tanned leather wherein hides or skins or mineral tanned leather are treated with condensates according to claim 1 or the mixture according to claim 14 in aqueous liquor.

17. Leathers or furs tanned or retanned using at least one condensate according to at least one of claims 1 or 14.

18. A Process wherein the condensates according to at least one of claim 1 or 14 are used as auxiliaries for paper or textile applications.
